(19) United States
(12) Patent Application Publication
(10) Pub. No.: US 2007/0007196 A1
(43) Pub. Date: Jan. 11, 2007

(54) Filter cartridge for fluid for treating surface of electronic device substrate

(75) Inventors: Makoto Komatsu, Fujisawa-shi, Kanagawa (JP); Kunio Fujiwara, Kanagawa (JP); Yukio Hashimoto, Tokyo (JP)

Correspondence Address: WENDEROTH, LIND & PONACK, L.L.P., 2033 K STREET N. W., SUITE 800, WASHINGTON, DC, 20006-1021, US

(73) Assignee: EBARA CORPORATION, Tokyo (JP)

(21) Appl. No.: 10/554,585

(22) PCT Filed: Apr. 28, 2004
(86) PCT No.: PCT/JP04/06190

§ 371 Date: Sep. 14, 2006

(30) Foreign Application Priority Data
May 7, 2003 (JP) 2003-128579

(51) Int. Cl. B01D 24/00

(52) U.S. Cl. 210/500.1

(57) ABSTRACT

It is the purpose of the present invention to provide filter cartridges which can suitably be utilized in purifying chemical fluids for treating the surface of an electronic device substrate to be used in the semiconductor industry, particularly fluids containing a basic compound such as ammonia and an ammonium salt, or hydrofluoric acid (HF). The filter cartridges relating to the present invention which are used in removing metallic impurities contained in a chemical fluid for treating the surface of an electronic device substrate by treating the chemical fluid, is characterized by having a filter material incorporated therein, into which functional groups compatible with the existing morphology of the metallic impurities to be removed are incorporated in compliance with the constituents of the chemical fluid to be treated and the types of the metallic impurities to be removed.

### FIELD OF INVENTION

The present invention relate to a filter cartridge which can be suitably used in purifying a chemical fluid for treating the surface of an electronic device substrate to be used in the semiconductor industry, particularly a fluid containing a basic compound such as an amine and an ammonium salt, and hydrofluoric acid (HF) as the constituents. It also relates to a method of efficiently removing various types of metallic impurities contained in the chemical fluid in trace amounts by using such a filter cartridge. The chemical fluids which can be subjected to the purification treatment according the present invention include, for example, an ammonia/hydrogen peroxide mixed aqueous solution, a dilute hydrofluoric acid (DHF) fluid and a buffered hydrofluoric acid (BHF) fluid which are used as the substrate cleaning agents, a photoresist developer and a photoresist stripper.

### BACKGROUND ART

In recent years, with the progress of the semiconductor production technology, the densification of a semiconductor device and miniaturization of the line width have advanced at a remarkable speed. Accompanied by this, the requirement relating to the cleanliness of chemical fluids to be used in the semiconductor production process, for example, fluids such as a photoresist, a thinner, a photoresist developer, a photoresist stripper, an insulation material and an anti-reflective coating (ARC), and ultrapure water, an organic solvent, an ammonia/hydrogen peroxide mixed aqueous solution, a dilute hydrofluoric acid (DHF) fluid, a buffered hydrofluoric acid (BHF) fluid and the like as the cleaning fluids, particularly the number of trace level fine particles and the concentration of trace level metals and metallic ion impurities contained in these fluids have become severer and severer in recent years. According to ITRS 2000 (International Technology Roadmap for Semiconductors 2000), the prediction that the level of DRAM ½ Pitch would come to 130 nm in 2003, and would come to 100 nm in 2005 was reported. Namely, it is anticipated that in the near future, it will be required to remove fine particles having a size of not smaller than the ½Pitch level as an impurity contained in the above described chemical fluids. This is because severe cleanliness from fine particles directly affects the production yield of semiconductor devices. Further, it is anticipated that the concentration of trace level metals and metallic ions to be required for the chemical fluids to be used in the semiconductor production process will be required to be 2×10⁹ atoms/cm² as the cleanliness on the wafer surface in 2005, and the requirement standards relating to the cleanliness of the chemical fluids to be used inevitably become severer year by year. Namely, the progress of the semiconductor production technology and the improvement of product performance and yield frequently depend on the progress of the technique of removing impurities such as fine particles, trace level metals and metallic ions from the chemical fluids to be used in the production process to purify them, and it is indispensable to develop a technique to achieve the above described level relating to the concentration of fine particles, trace level metals and metallic ions in the chemical fluids to be used with considering the rapid development heretofore in the semiconductor industry and the positive growth hereinafter.

The chemical fluids containing basic compounds which are used in the semiconductor production, for example, an ammonia/hydrogen peroxide mixed aqueous solution (called as “SC-1”), a dilute hydrofluoric acid (DHF) fluid and a buffered hydrofluoric acid (BHF) fluid which are used as the substrate cleaning agents or a photoresist developer and a photoresist stripper contain a basic compound such as an amine (for example, ammonia and primary to tertiary amines) and an ammonium salt (for example, a salt of ammonia, salts of primary to tertiary amines and a quaternary ammonium salt), and hydrofluoric acid (HF) as the main constituents. For example, SC-1 contains ammonia and hydrogen peroxide, the photoresist developer contains a quaternary ammonium salt, and the photoresist stripper typically contains ammonia, hydroxylamine, NH₃F, hydrofluoric acid and the like. The amines and the ammonium salts possess properties as a metal ligand in water or in a solvent to form metal complexes with a transition metal or the like. Further, particularly the amines possess the properties as a base, that is, the properties of forming hydroxide ions. Similarly, hydrofluoric acid possesses the properties of forming a metal complex with a transition metal or the like. Accordingly, in the chemical fluid containing a basic compound such as an amine and an ammonium salt, and hydrofluoric acid as the constituents, the existing morphology of dissolved metallic impurities varies depending on respective metal species and the properties of respective chemical fluids, which makes removal of trace level metallic impurities, that is, purification of the chemical fluids difficult.

By taking note of iron and copper ions in the HF chemical liquid to be used in etching an Si substrate, as the method of removing these heavy metallic ions from the HF chemical liquid, a method of mixing the same substance as the substance to be etched, in other words, Si particles with an ion exchange resin to prepare a filter and treating the chemical fluid by passing the chemical fluid through this filter is proposed (Japanese Patent Publication (KOKAI) JP-A-H06-31267A). This technique efficiently removes metallic impurities by utilizing adsorption of a Cu ion to the Si particles and removal of an Fe ion by the ion exchange resin, but it was difficult to increase the removal efficiency of metallic impurities to a sufficient level by the filter cartridge using an ion exchange resin and finely pulverized Si particles. The main reason is that the adsorption of the Cu ion to the Si particle surface is rate-determined by the oxidation reaction of a metallic ion to be adsorbed, and with the filter cartridge designed by the above described technique, the surface area of the Si particle surface which becomes the site of metal adsorption is insufficient at the liquid flow speed in actual use. Further, in Japanese Patent Publication (KOKAI) JP-A-2002-80207A and JP-A-H10-7407, a method of purifying hydrogen peroxide water which comprises simultaneously removing metallic impurities and anions contained in coarse hydrogen peroxide solution by treating the solution by a column packed with cation exchange resins and a column packed with anion exchange resins or chelating agent-adsorbed anion exchange resins is proposed. However, in this case, bead ion exchange resins are used, and thus with respect to the removal of metallic ions, the diffusion of the metallic ions within fine pores of the ion exchange resins comes to the rate-determining step. Thus, in order to obtain sufficient efficiency of removing metallic impurities by treating a stripper containing metallic impurities or an ammonia/hydrogen peroxide solution at a flow speed in actual use, it is necessary to construct a large-scale apparatus. Accordingly, this method has not been used at the point of use (POU) of a semiconductor production process which requires a compact apparatus from the standpoint of space.

Further, since it is difficult to remove metallic impurities from an ammonia/hydrogen peroxide solution or a stripper, a method of adding a metal chelating agent or a complexing agent to these chemical fluids as an anti-adhesion agent for inhibiting adhesion of metallic impurities to the surface of a silicon wafer to thereby reduce the contamination speed of metal onto the silicon wafer is proposed (Japanese Patent Publication (KOKAI) JP-A-2002-114744). However, according to this method, contamination of the surface of the wafer is caused by oxidation decomposition of the complexing agent or by the complexing agent itself, and thus the expected effect could not be much obtained.

### DISCLOSURE OF INVENTION

As explained above, it has been impossible by the existing techniques to remove metallic impurities from various types of chemical fluids containing a basic compound, hydrofluoric acid and the like to be used in the semiconductor production process at the point of use (POU) at a flow rate and metal removal efficiency which are applicable to the actual process. It is strongly desired in the present semiconductor industry to provide a novel and effective technique for removing metallic impurities having an ability beyond the limit by the existing chemical liquid cleaning technique.

Recognizing importance of iron, copper and calcium which come to a greatest problem as metallic impurities in the semiconductor production process, the present inventors were strenuously investigating the existing morphology of these metal species to be adsorbed in a target chemical fluid to be treated. As a result, the present inventors have found the adsorptive removal conditions by chemical adsorption which is derived by taking the predominant existing morphology of metallic impurities in the actual process into account. Furthermore, recognizing importance of the diffusion of ions in the boundary phase on the surface of an ion exchanger which comes to the rate-determining step of the ion exchange reaction, the present inventors provides an ion exchange material and a chelating material which have very high metal adsorptive efficiency even at a high flow rate of a fluid by introducing various ion exchange groups and chelate groups into a porous membrane base material and a fiber base material such as a woven fabric and a nonwoven fabric which have a very large surface area of the base material per unit volume. It has been found that by assembling a filter cartridge with the use of an ion exchanger or a chelating body to be formed from the base material having this large surface area, it has become possible to form an undersize and compact filter cartridge. Using the filter cartridge, by the operation of passing and filtering a fluid at POU which is conventionally performed in the semiconductor production process, metallic impurities contained in various chemical fluids can be removed by adsorption to dramatically improve the cleanliness of the chemical fluids. Namely, the present invention has enabled removal by adsorption of metallic impurities, particularly iron and/or copper and/or calcium from the fluid for treating the surface of an electronic device substrate, for example, chemical fluids containing a basic compound represented by an amine such as ammonia, and hydrofluoric acid including an ammonia/hydrogen peroxide solution, a dilute hydrofluoric acid (DHF) fluid, a buffered hydrofluoric acid (BHF) fluid, a photoresist developer, a photoresist stripper and the like which are important chemical fluids in the semiconductor process, which has been difficult up until now, by a simple operation of merely passing a fluid through the filter cartridge.

According to a broadest embodiment, the present invention relates to a filter cartridge to be used for removing metallic impurities contained in a chemical fluid for treating the surface of an electronic device substrate by treating the chemical fluid, which cartridge has a filter material incorporated therein into which functional groups compatible with the existing morphology of target metallic impurities to be removed are introduced in compliance with the constituents of the chemical fluid to be treated and the types of the target metallic impurities to be removed. The filter cartridge relating to the present invention can be very suitably used particularly in removing metallic impurities from various types of chemical fluids containing an amine and/or an ammonium salt and/or hydrofluoric acid as the constituent.

According to a preferred embodiment of the present invention, a filter cartridge for removing iron, copper and calcium from a fluid containing ammonia and hydrogen peroxide, which is characterized in that functional groups composed of the combination of a strongly acidic cation exchange group with a quaternary ammonium group or an amidoxime group or a phosphonic acid group are introduced thereinto, is provided.

According to another embodiment of the present invention, a filter cartridge for removing iron, copper and calcium from a photoresist developer, which is characterized in that functional groups composed of the combination of a strongly acidic cation exchange group with a chelate group containing an amino group, particularly an iminodiethanol group, a diethylenetriamine group or a polyethyleneimine are introduced thereinto, is provided.

Further, according to a still another embodiment of the present invention, a filter cartridge for removing iron, copper and calcium from a photoresist stripper, which is characterized in that function groups composed of the combination of a strongly acidic cation exchange group with an amidoxime group or a phosphonic acid group are introduced thereinto, is provided.

### BRIEF EXPLANATION OF DRAWINGS

FIG. 1 is a graph showing the experimental results of Example 1 and Comparative example 1.

FIG. 2 is a graph showing the experimental result of Example 6.

FIG. 3 is a schematic diagram of an apparatus for passing a fluid in circulation used in Example 7.

FIG. 4 is a graph showing the experimental result of Example 7.

FIG. 5 is a graph showing the experimental result of Example 8.

### EMBODIMENTS OF THE INVENTION

The embodiments of the present invention will be explained in detail below.

The filter cartridge according to the present invention is characterized by having a filter material constituted of a fibrous material and/or a porous membrane material incorporated therein, into which a specified ion exchange group and/or a specified chelate group selected in compliance with the existing morphology of a target metallic impurity to be removed in a fluid to be treated is introduced.

As the fiber base material which can be used as the base material for forming a fibrous material which constitutes the filter material of the present invention, fibers of a polymeric material, woven fabrics or nonwoven fabrics which is an assembly of the fibers, can suitably be used. The fibrous material of the polymeric material includes polyolefins such polyethylene and polypropylene; halogenated polyolefins such as PTFE, polyvinylidene fluoride and polyvinyl chloride; polyesters such as polycarbonate; polyethers; polyether-sulfones; cellulose and these copolymers; and olefin copolymers such as an ethylene-ethylene tetrafluoride copolymer and an ethylene-vinyl alcohol copolymer (EVAL) and the like. The fibrous materials prepared by these (co)polymers have an increased surface area, which results in an increased capacity of removing trace level ions and, in addition, are lightweight and easy in fabrication. The concrete forms of the fibers include continuous fibers and processed articles thereof, discontinuous fibers and processed articles thereof, and their cut single fibers and the like. The continuous fibers include, for example, continuous filaments can be mentioned, and the discontinuous fibers include, for example, staple fibers. Further, the processed articles of the continuous fibers and discontinuous fibers include various woven fabrics and nonwoven fabrics produced from these fibers can be mentioned. The woven fabric/nonwoven fabric materials can be suitably used as the base materials for the radiation-induced graft polymerization as will be described below and are lightweight and easily processed into filters, and thus are suitable as the fiber base materials to be used in forming filter cartridges relating to the present invention.

In the present invention, as the means to introduce an ion exchange group and/or a chelate group into the fiber base material, the graft polymerization method can be used, and above all, the radiation-induced graft polymerization can suitably be used. The radiation-induced graft polymerization method is a method of introducing a desired graft side chain on to the polymer main chain of an organic polymer base material by irradiating the polymer base material with radiation to generate radicals and reacting a graft monomer with the radicals. The radiation-induced graft polymerization method can freely control the length and the number of the graft chain, and further can introduce the graft side chain into the existing polymeric base materials having various forms, and thus is most suitably used for the object of the present invention. When the radiation-induced graft polymerization is employed, the ion exchange group and/or the chelate group is introduced into the polymer base material in the form of a graft side chain having these groups.

The radiation which can be suitably used in the radiation-induced graft polymerization method to be used for the object of the present invention, include α-rays, β-rays, γ-rays, electron beams, ultraviolet rays and the like. Use of γ-rays and electron beams is suited in the present invention. The radiation-induced graft polymerization may classified into two groups. A pre-irradiation graft polymerization is a method of pre-irradiating a graft base material with radiation and then bringing a polymerizable monomer (graft monomer) into contact with the irradiated base material. A simultaneous irradiation graft polymerization is a method of effecting the irradiation with radiation in the co-presence of the base material and the monomer. Any one of these methods can be used in the present invention. Further, depending on the method of contacting the monomer with the base material, there are a liquid phase graft polymerization method of conducting polymerization while the base material is dipped in the monomer solution, a gas phase graft polymerization method of conducting polymerization while the base material is contacted with the vapor of the monomer, and a impregnation gas phase graft polymerization method of dipping the base material in the monomer solution, and then taking the base material out of the monomer solution and effecting reaction in a gas phase, and the like. Any of these methods can be used in the present invention.

Fibers and woven fabrics and nonwoven fabrics which are assembly of fibers are most suitable materials to be used as the organic polymer base materials for producing the filter material relating to the present invention. These materials are easy to retain a monomer solution, and thus suited for use in the impregnation gas phase graft polymerization method. Further, introduction of a functional group such as an ion exchange group and/or a chelate group into porous membrane base materials invites deterioration of the mechanical strength of the base material, and thus the functional group cannot be introduced beyond a certain amount, but the fiber materials such as woven fabrics and nonwoven fabrics do not invite the deterioration of mechanical strength even by introducing functional groups such as an ion exchange group and a chelate group thereinto by the radiation-induced graft polymerization method, and thus enables introduction of a much larger amount of functional groups than the porous membrane materials.

In the present invention, the ion exchange group which can be introduced into the fiber base material may include, as cation ion exchange groups, strongly acidic cation exchange groups such as a sulfonic acid group, weakly acidic cation exchange groups such as a phosphoric acid group and a carboxyl group; and as anion exchange groups, strongly basic anion exchange groups such as a quaternary ammonium group and weakly basic anion exchange groups such as primary, secondary and tertiary amino groups. Further, the chelate groups may include functional groups derived from iminodiacetic acid and its sodium salts, functional groups derived from various amino acids, for example, glutamic acid, aspartic acid, lysine, proline and the like, a functional group derived from iminodiethanol, dithiocarbamic acid group, thiourea group and the like.

In preparation of the fibrous material which constitutes the filter cartridge according to the present invention, any of a method of graft polymerizing a polymerizable monomer having the above described ion exchange group and/or chelate group on to the main chain of the fiber base material and a method of graft polymerizing a polymerizable monomer which does not have the above described ion exchange group and/or chelate group in itself but has a functional group convertible to these groups on to the main chain of the fiber base material and then converting the functional group on the graft side chain to the ion exchange group and/or chelate group can be employed. The polymerizable monomers having an ion exchange group which can be used for this purpose include polymerizable monomers having a sulfonic group such as styrenesulfonic acid, vinylsulfonic acid, their sodium salts and ammonium salts; polymerizable monomers having a carboxyl group such as acrylic acid and methacrylic acid; polymerizable monomers having an amine-containing ion exchange group such as vinylbenzyl-trimethylammoniumchloride (VBTAC), dimethyl-aminoethylmethacrylate (DMAEMA), diethylaminoethyl methacrylate (DEAEMA) and dimethyl-aminopropyl acrylamide (DMAPAA). The polymerizable monomers which do not have the above described ion exchange group and/or chelate group in itself but have a functional group convertible to these groups include glycidyl methacrylate, styrene, acrylonitrile, acrolein, chloromethylstyrene and the like. For example, by graft polymerizing styrene on to the fiber base material and then reacting sulfuric acid or chlorosulfonic acid to effect sulfonation, a sulfonic acid group of a strongly acidic cation exchange group can be introduced on the graft side chain. Further, for example, by graft polymerizing chloromethylstyrene on to the fiber base material and then dipping the base material in an iminodiethanol aqueous solution, an iminodiethanol group of a chelate group can be introduced on the graft side chain. Furthermore, for example, by graft polymerizing a p-haloalkylstyrene on to the fiber base material, then substituting the halogen on the graft side chain with an iodine, reacting diethyl iminodiacetate to substitute the iodine with a diethyl iminodiacetate group, and further hydrolyzing the ester bond with a sodium hydroxide aqueous solution, an iminodiacetic acid group of a chelate group can be introduced on the graft side chain.

The fiber base material which can be used in the present invention preferably has an average fiber diameter of 0.1 μm to 50 μm and an average pore diameter of 0.1 μm to 100 μm. In a preferred embodiment of the present invention, the fiber base material preferably has an average fiber diameter of 0.1 μm to 20 μm and an average pore diameter of 1 μm to 20 μm. In a more preferred embodiment of the present invention, the average fiber diameter of the fiber base material is preferably 0.2 μm to 15 μm, more preferably 0.5 μm to 10 μm. Further, the average pore diameter of the fiber base material of the present invention is preferably 1.0 μm to 10 μm, more preferably 1.0 μm to 5 82 m. In the present invention, the average pore diameter of the fibrous material means a value measured by the bubble-point method. It has been found that the removability of various types of metallic impurities is dramatically increased by forming the filter cartridge with the use of a fiber base material having a smaller average fiber diameter and a smaller average pore diameter as described above.

According to another embodiment of the present invention, the porous membrane material obtained by introducing a specified functional group into a porous membrane base material can be incorporated into the filter cartridge as the filter material. The porous membrane material which can be used in the present invention includes the existing porous molecular membranes including porous polymer membrane and inorganic substance. The materials of the membranes include polyolefins such as polyethylene and polypropylene; halogenated polyolefins such as PTFE, polyvinylidene fluoride and polyvinyl chloride; polyesters such as polycarbonate; polyethers; polyethersulfones; polysulfones; cellulose; and their copolymers; olefin copolymers such as an ethylene-ethylene tetrafluoride copolymer, an ethylene-vinyl alcohol copolymer (EVAL) and the like.

The porous membrane material which can be used in the present invention preferably has an average pore diameter of 0.02 μm to several microns, more preferably 0.02 μm to 0.5 μm. In the present invention, the average particle diameter means a value measured by the same measuring method as in measurement of the average particle diameter of the above explained fiber base material.

As the method of introducing an intended functional group into the porous membrane base material, the graft polymerization method as explained above, particularly the radiation-induced graft polymerization method can be utilized. Further, as another technique, introduction of the functional group into the porous membrane base material is also possible by a chemical modification method using a crosslinking polymerization method. For example, as disclosed in Japanese Patent Publication (KOHYO) JP-A-H09-512857, various types of functional groups can be introduced into the surface of the porous membrane base material by impregnating the porous membrane base material with a solution containing a polymer having various types of functional groups such as polyvinyl alcohol in a solvent and a free radical polymerization initiator such as a persulfate, and crosslinking and insolubilizing the polymer in the solvent by irradiation with radiation or by heating to chemically bond the functional group to the surface of the porous membrane base material. The composite porous membrane prepared by this technique maintains the structural properties of the porous base material and, simultaneously, has a cation exchange group, an anion exchange group, a chelate group and the like introduced on its surface. As the polymer constituting the polymer solution to be used in this technique, in addition to the above described polyvinyl alcohol, water soluble polymers such as acrylamide, acrylic acid, methacrylic acid, vinylamine, vinylsulfonic acid, 4-vinyl-pyridine or a mixture thereof can be used, and the functional group which each of the polymers has is introduced onto the surface of the porous membrane base material. The free radical polymerization initiator which can be used for the above described purpose includes, concretely, 2,2′-azobis(isobutyronitrile), ammonium persulfate, potassium persulfate, sodium persulfate, potassium peroxy diphosphate, benzophenone, benzoyl peroxide and the like.

Further, the above described surface modification method by the crosslinking polymerization method can also be employed as the means to introduce various types of functional groups into a fibrous material such as a woven fabric and a nonwoven fabric.

According to the present invention, a filter cartridge is prepared with the use of a fiber base material or porous membrane base material into which functional groups are introduced by graft polymerization or the like, and thus it is possible to purify a chemical fluid at a higher flow rate by a much smaller unit than the conventional filter cartridge into which resin beads or the like are incorporated. Furthermore, according to the present invention, it is possible to purify the chemical fluid at POU in a semiconductor production apparatus. This enables removal of impurities including contaminants from the chemical fluid delivery system and the apparatus before the chemical fluid is directly contacted with wafers, and accordingly the cleanliness of the chemical fluid is dramatically improved.

The present inventors further aim at the relationship between the constituents and the properties of each chemical fluid used in the semiconductor industry and the morphology of a target metallic impurity to be removed in the chemical fluid, and accomplished the present invention comprising removing the metallic impurity by the optimum functional group compatible to the existing morphology of the metallic impurity.

For example, an ammonia-hydrogen peroxide mixed fluid (called as “APM” or “SC-1”) which is used as the substrate cleaning agent is a mixed fluid of ammonia, hydrogen peroxide and pure water having a pH of about 7 to 12 depending on the composition. In this chemical fluid, copper forms a 4-coordination type metal complex formed by coordination bonding of four molecules of ammonia as the ligands to one molecule of a copper ion and dissolves in the chemical fluid as a complex ion having a charge of a valence of +2. Accordingly, in order to remove the copper in the ammonia-hydrogen peroxide mixed fluid, a filter constituted of a cation exchange group-introduced fibrous material or porous membrane material is effective. As the cation exchange group to be introduced into the filter base material for this purpose, a strongly acidic cation exchange group such as a sulfonic acid group is preferred. On the other hand, iron forms a mixture of two types of metal complexes of a 6-coordination type metal complex formed by coordination bonding of four molecules of hydroxide ions and two molecules of ammonia to one molecule of an iron ion and a 6-coordination type complex formed by coordination bonding of three molecules of hydroxide ions and three molecules of ammonia to one molecule of an iron ion, and dissolves in the chemical fluid as a mixture of complex ions having a charge of a valence of −1 and zero, respectively. Accordingly, in order to remove the iron in the ammonia-hydrogen peroxide mixed fluid, a filter constituted of an anion exchange group- or chelate group-introduced fibrous material or porous membrane material is effective. As the anion exchange group which is introduced into the filter base material for this purpose, a strongly basic anion exchange group such as a quaternary ammonium group is preferred and as the chelate group, an amidoxime group or a phosphonic acid group is preferred. Furthermore, calcium is present in the form of a hydroxide and dissolves in the chemical fluid as an ion having a charge of a valence of +1. Accordingly, in order to remove the calcium in the ammonia-hydrogen peroxide mixed fluid, a filter constituted of a strongly acidic cation exchange group-introduced fibrous material or porous membrane material is effective. As the strongly acidic cation exchange group to be introduced into the filter base material for this purpose, a sulfonic acid group is preferred. In conclusion, in order to remove the metallic impurities of iron, copper and calcium in the ammonia-hydrogen peroxide mixed fluid, it is preferred to use a filter cartridge into which the combination of a strongly acidic cation exchange group such as a sulfonic acid group and an quaternary ammonium group of a strongly basic anion exchange group or the combination of a strongly acidic cation exchange group and a chelate group, particularly an amidoxime group or a phosphonic group is introduced.

The photoresist developer which is used in the semiconductor production process typically contains tetramethylammonium hydroxide (TMAH) of a quaternary ammonium salt as the main component. The aqueous solution containing TMAH which is strongly basic has a pH of about 12 to 14 and the concentration of a hydroxide ion is very high. In such a chemical fluid, copper forms a hydroxide complex and dissolves in the chemical fluid as a complex ion having a charge of a valence of −1 or −2. Accordingly, in order to remove the copper in thephotoresist developer, a filter constituted of a chelate group-introduced fibrous material or porous membrane material is effective. As the chelate group to be introduced into the filter base material for this purpose, a functional group containing an amino group is preferred, and an iminodiethanol group, a diethylenetriamine group or polyethyleneimine is more preferred. Iron forms a hydroxide complex and dissolves in the chemical fluid as a complex iron having a charge of a valence of −1. Thus, in order to remove the iron in the photoresist developer, a filter constituted of a chelate group-introduced fibrous material or porous membrane material is effective. As the chelate group to be introduced into the filter base material for this purpose, a functional group containing an amino group is preferred, and an iminodiethanol group, a diethylenetriamine group or polyethyleneimine is more preferred. Calcium is bonded to a hydroxide ion to form an ion having a valence of +1 which dissolves in the chemical fluid. In order to remove this complex ion, a filter constituted of a strongly acidic cation exchange group-introduced fibrous material or porous membrane material is effective. As the strongly acidic cation exchange group to be introduced into the filter base material for this purpose, a sulfonic acid group is preferred. In conclusion, in order to remove the metallic impurities of iron, copper and calcium in the photoresist developer, it is preferred to use a filter cartridge into which the combination of a strongly acidic cation exchange group and a chelate group, preferably a functional group containing an amino group, particularly an iminodiethanol group, a diethylenetriamine group or polyethyleneimine is introduced.

The resist stripper which is used in the semiconductor production process contains ammonia, hydoxylamine, NH₃F, hydrofluoric acid and various types of organic solvents. In this chemical fluid, copper forms an ammonia-fluorine complex, an ammonia complex, a fluorine complex and the like, and dissolves in the chemical fluid as a complex ion having a charge of a valence of −1 or zero. Accordingly, in order to remove the copper in the photoresist stripper, a filter constituted of a chelate group-introduced fibrous material or porous membrane material is effective. As the chelate group to be introduced into a filter base material for this purpose, an amidoxime group or a phosphonic acid group is preferred. Iron forms an ammonia-fluorine complex, an ammonia complex, a fluorine complex and the like in the same manner and dissolves in the chemical fluid as a complex ion having a charge of a valence of −1 or zero. Accordingly, in order to remove the iron in the photoresist stripper, a filter constituted of a chelate group-introduced fibrous material or porous membrane material is effective. As the chelate group to be introduced into the filter base material for this purpose, an amidoxime group or a phosphonic acid group is preferred. Calcium dissolves in the chemical fluid as an ion having a valence of +2. In order to remove this ion, a filter constituted of a strongly acidic cation exchange group-introduced fibrous material or porous membrane material is effective. As the strongly acidic cation exchange group to be introduced into the filter base material for this purpose, a sulfonic acid group is preferred. In conclusion, in order to remove the metallic impurities of iron, copper and calcium in the photoresist stripper, it is preferred to use a filter cartridge into which the combination of a strongly acid cation exchange group and a chelate group, particularly an amidoxime or a phosphonic acid group is introduced.

A dilute hydrofluoric acid (DHF) fluid which is used as a substrate cleaning agent in the semiconductor production process contains hydrofluoric acid (HF) in pure water and has a pH of about 1 to 5. In this chemical fluid, copper forms a fluorine complex and dissolves in the chemical fluid as a complex ion having a charge of a valence of +1. Accordingly, in order to remove the copper in a dilute hydrofluoric acid fluid, a filter constituted of a strongly acidic cation exchange group-introduced fibrous material or porous membrane material is effective. As the strongly acidic cation exchange group to be introduced into the filter base material for this purpose, a sulfonic acid group is preferred. Iron forms a fluorine complex in the same manner and dissolves in the chemical fluid as a complex ion having a charge of a valence of −1 or zero. Accordingly, in order to remove the iron in a dilute hydrofluoric acid fluid, a filter constituted of a chelate group-introduced fibrous material or porous membrane material is effective. As the chelate group to be introduced into a filter base material for this purpose, an amidoxime group or a phosphonic acid group is preferred. Calcium dissolves in the chemical fluid as a calcium ion having a valence of +2. In order to remove this calcium ion, a filter constituted of a strongly acidic cation exchange group-introduced fibrous material or porous membrane material is effective. As the strongly acidic cation exchange group to be introduced into a filter material for this purpose, a sulfonic acid group is preferred. In conclusion, in order to remove metallic impurities of iron, copper and calcium in the dilute hydrofluoric acid fluid, it is preferred to use a filter cartridge into which the combination of a strongly acid cation exchange group and a chelate group, particularly an amidoxime group or a phosphonic acid group is introduced.

The buffered hydrofluoric acid fluid (BHF) which is used as a substrate cleaning agent in the semiconductor production process contains hydrofluoric acid (HF) and ammonia in pure water and has a pH of about 6 to 10. In this chemical fluid, copper forms an ammonia-fluorine complex and dissolves in the chemical fluid as a complex ion having a charge of a valence of −1 or zero. Thus, in order to remove the copper in the buffered hydrofluoric acid fluid, a filter constituted of a chelate group-introduced fibrous material or porous membrane material is effective. As the chelate group to be introduced into a filter base material for this purpose, an amidoxime group or a phosphonic acid group is preferred. Iron forms an ammonia/fluorine complex in the same manner and dissolves in the chemical fluid as a complex ion having a charge of a valence of −1 or zero. Thus, in order to remove the iron in the buffered hydrofluoric acid fluid, a filter constituted of a chelate group-introduced fibrous material or porous membrane material is effective. As the chelate group to be introduced into a filter base material for this purpose, an amidoxime group or a phosphonic acid group is preferred. Calcium dissolves in the chemical fluid as a calcium ion having a valence of +2. In order to remove this ion, a filter constituted of a strongly acidic cation exchange group-introduced fibrous material or porous membrane material is effective. As the strongly acidic cation exchange group to be introduced into a filter base material for this purpose, a sulfonic acid group is preferred. In conclusion, in order to remove metallic impurities of iron, copper and calcium in the buffered hydrofluoric acid fluid, it is preferred to use a filter cartridge into which the combination of a strongly acid cation exchange group and a chelate group, particularly an amidoxime group or a phosphonic acid group is introduced.

The filter cartridge according to the present invention can be formed by selecting a fibrous material and/or a porous membrane material or the combination of the fibrous material and the porous membrane material into which most suitable functional groups compatible with the properties of a target chemical fluid to be treated and the existing morphology of metallic impurities contained in the chemical fluid, laminating this material and folding it in the laminated state into a pleat or cylindrically winding it around an inner core. The filter cartridge according to the present invention into which specified functional groups are introduced may replaced with or combined with a filter for removing fine particulate metallic impurities which has been installed at POU. This enables efficient removal of impurities of fine particulate impurities and trace level metallic impurities at the same time by the same apparatus and operation as before. In other words, the present invention has achieved removal of trace level metallic impurities by a single filtration step, and thus has become very easily applicable to the actual apparatus which is being used at present in the production of semiconductor devices. Also from this point, the present invention has a great advantage in the semiconductor industry.

The filter cartridge according to the present invention may be installed in the middle of the path in circulation to a chemical fluid tank in the line for feeding various chemical fluids in the semiconductor device production process, by which the metallic impurities in the chemical fluids can be greatly reduced. Further, by installing this filter cartridge according to the present invention at POU on the chemical fluid feed line, the metallic impurities and fine particulate impurities contained in each chemical fluid can be efficiently removed. In this instance, not only the metallic impurities originally present in the chemical fluids can be removed but also contamination from chemical fluid transfer paths such as piping and joints can be dealt with.

### INDUSTRIAL APPLICABILITY

According to the present invention, metallic impurities can be very efficiently removed by treating chemical fluids using the filter cartridge into which optimum functional groups compatible with the type of the target chemical fluid to be treated and the target metallic impurity to be removed are introduced.

The present invention will be further explained by the following examples, but theses examples show some concrete examples and the present invention is not to be limited by the description thereof.

### EXAMPLE 1

Preparation of Sulfonic Acid Type Cation Exchange Nonwoven Fabric

Eighty-three grams of a nonwoven fabric made of polyethylene fibers (a product of Du Pont, trade name “Tyvek”, average fiber diameter: 0.5 to 10 μm, average pore diameter: 5 μm (measured by the bubble-point method), a real density: 65 g/m², thickness: 0.17 mm) was irradiated with electron beams at 150 kGy in a nitrogen atmosphere. This irradiated nonwoven fabric was impregnated with styrene and placed in a glass vessel. Pressure in the vessel was reduced using a vacuum pump, and graft polymerization reaction was conducted at 50° C. for three hours. The grafted nonwoven fabric was taken out and treated in toluene at 60° C. for three hours to remove homopolymers. The obtained nonwoven fabric was further washed with acetone and then dried at 50° C. for 12 hours to obtain 136 g of a styrene-grafted nonwoven fabric. The grafting ratio was 64%.

The obtained styrene-grafted nonwoven fabric was dipped in a chlorosulfonic acid/dichloromethane mixed fluid (2:98 by weight ratio) to conduct sulfonation reaction at 0° C. for one hour. The nonwoven fabric was taken out and washed with a methanol/dichloromethane mixed fluid (1:9 by weight ratio), methanol, and then water, and then dried to obtain a sulfonic acid type cation exchange nonwoven fabric 1 having a thickness of 0.27 mm and an ion-exchange capacity of 328 meq/m².

### EXAMPLE 2

Preparation of Quaternary Ammonium Type Anion Exchange Nonwoven Fabric

Two hundred and thirteen grams of the nonwoven fabric as in Example 1 was irradiated with electron beams under the same conditions as in Example 1, and then dipped in chloromethylstyrene (450 g, a product of Seimi Chemical, trade name “CMS-AM”) in a glass vessel. After reducing the pressure in the vessel by a vacuum pump, graft polymerization reaction was conducted at 50° C. for three hours. The resulting nonwoven fabric was taken out and washed three times with acetone (3 L) and dried at 50° C. for 12 hours to obtain 430 g of a chloromethylstyrene-grafted nonwoven fabric. The grafting ratio was 102%. The obtained grafted nonwoven fabric was dipped in a mixed solution of a 30% trimethylamine aqueous solution (600 mL), ethanol (1 L) and pure water (2.8 L). The reaction was conducted at 50° C. for 24 hours to form quaternary ammonium groups. The resulting nonwoven fabric was taken out and washed with pure water, 0.5 mol/L hydrochloric acid, and further with pure water, and then dried to obtain a quaternary ammonium type anion exchange fabric 2 having a thickness of 0.31 mm and an ion-exchange capacity of 395 meq/m².

### EXAMPLE 3

Preparation of Iminodiethanol Type Chelating Nonwoven Fabric

Eighty-three grams of a nonwoven fabric irradiated with electron beams under the same conditions as in Example 1 was impregnated with chloromethylstyrene (a product of Seimi Chemical, trade name “CMS-14”) and placed in a glass vessel. After reducing pressure by a vacuum pump, graft polymerization reaction was conducted at 50° C. for three hours. The resulting nonwoven fabric was taken out and treated in toluene at 60° C. for three hours to remove homopolymers. The resulting nonwoven fabric was further washed with acetone, and then dried under reduced pressure at 50° C. for 12 hours to obtain 154 g of a chloromethylstyrene-grafted nonwoven fabric. The grafting ratio was 85%. This nonwoven fabric was dipped in an iminodiethanol/isopropyl alcohol mixed solution (4:6 by weight ratio), and the reaction was conducted at 70° C. for 12 hours. The resulting nonwoven fabric was taken out and washed with methanol and then pure water, and dried to obtain an iminodiethanol type chelating nonwoven fabric 3 having a thickness of 0.28 mm and an amount of the introduced iminodiethanol groups of 285 meq/m².

### EXAMPLE 4

Preparation of Amidoxime Type Chelating Nonwoven Fabric

Eighteen point eight grams of a nonwoven fabric irradiated with electron beams under the same conditions as in Example 1 was impregnated with an acrylonitrile/toluene mixed fluid (2:1 by volume ratio) and placed in a glass vessel. After reducing pressure by a vacuum pump, graft polymerization reaction was conducted at 60° C. for three hours. The resulting nonwoven fabric was taken out and treated in dimethylformamide at 40° C. for 30 minutes to remove homopolymers. The obtained nonwoven fabric was further washed with methanol, and then dried under reduced pressure at 50° C. for 12 hours to obtain 20.6 g of a nonwoven fabric having a grafting ratio of 13%. This nonwoven fabric was dipped in a hydroxylamine hydrochlorate (12 g) solution in a pure water (22 mL)/methanol (220 mL) mixed solution, and the reaction was conducted at 80° C. for 4 hours. The resulting nonwoven fabric was taken out, washed with pure water and dipped in a 3% ammonia water, and the reaction was conducted at 60° C. for 2 hours. The obtained nonwoven fabric was taken out and washed again with pure water, and dried to obtain 21.3 g of an amidoxime type chelating nonwoven fabric 4 having a thickness of 0.21 mm.

As explained below, experiment for evaluating the metal removal performance of the filters were performed by passing a model solution through the filters. The performance of each filter was evaluated by comparing the concentration of metallic impurities in the model solution with that in the effluent after filtration. The concentration of metallic impurities was determined using an atomic absorption spectrophotometer manufactured by Hitachi, Ltd., Z-9000.

### EXAMPLE 5

Evaluation for Removal of Copper from Ammonia-Containing Fluid

Operation experiment was conducted with the use of the sulfonic acid type cation exchange nonwoven fabric 1 as prepared in Example 1. The cation exchange nonwoven fabric 1 was cut into disks having a diameter of 47 mm (effective area: 13.1 cm²), and fixed to a filter holder. A 1.5% ammonia aqueous solution containing 140 ppb of copper was passed through the filter as the testing solution at a flow rate of 5.0 to 20 mL/min, and the copper concentration in the effluent was measured. At a flow rate of the solution in this range, the copper concentration in the effluent was reduced to the range of 1.0 to 4.0 ppb, and thus good performance of removing a copper impurity was exhibited.

### COMPARATIVE EXAMPLE 1

Evaluation for Removal of Iron from Ammonia-Containing Fluid

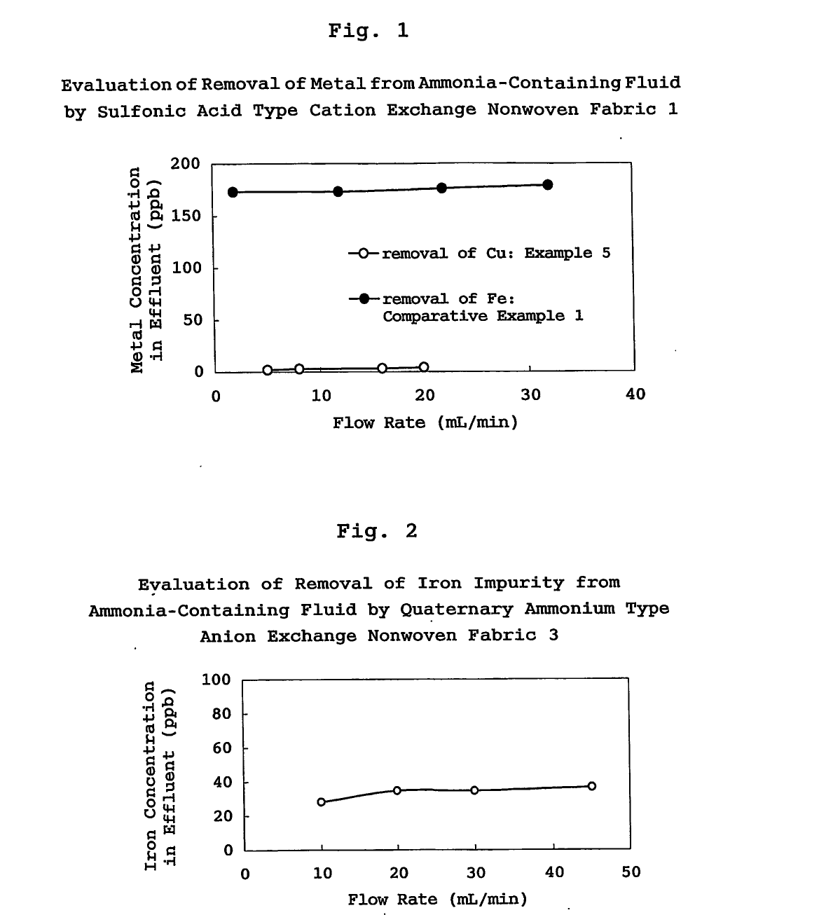

The sulfonic acid type cation exchange nonwoven fabric 1 as prepared in Example 1 was cut into disks having a diameter of 47 mm (effective area: 13.1 cm²), and fixed to a filter holder. A 1.5% ammonia aqueous solution containing 175 ppb of iron was passed through the filter as the testing solution at a flow rate of 5.0 to 40 mL/min, and the iron concentration in the effluent was measured. At a flow rate of the solution in this range, the iron concentration in the effluent was in the range of 173 to 174 ppb. Thus, iron was not removed at all. The results of Example 5 and Comparative Example 1 are shown in FIG. 1 in combination.

### EXAMPLE 6

Evaluation for Removal of Iron from Ammonia-Containing Fluid

Operation experiment was conducted with the use of the quaternary ammonium type anion exchange nonwoven fabric 2 as prepared in Example 2. The anion exchange nonwoven fabric 2 was cut into disks having a diameter of 47 mm (effective area: 13.1 cm²), and fixed to a filter holder. A 1.5% ammonia aqueous solution containing 100 ppb of iron was passed through the filter as the testing solution at a flow rate of 5.0 to 50 mL/min, and the iron concentration in the effluent was measured. At a flow rate of the solution in this range, the iron concentration in the effluent was reduced to the range of 28.0 to 34.0 ppb. Thus, good performance of removing an iron impurity was exhibited. The result of Example 6 is shown in FIG. 2.

Reviewing the results of the above described Examples 5 to 6 and Comparative Example 1 and FIGS. 1 and 2, it has been found that the anion exchange group-introduced filter cartridge is most suited in removing an iron impurity in a chemical fluid containing ammonia, and on the other hand, the cation exchange group-introduced filter cartridge is most suited in removing a copper impurity in a chemical fluid containing ammonia. Accordingly, it can be understood that constitution of a filter cartridge by combining a cation exchange group-introduced filter with an anion exchange group-introduced filter enables removal of both an iron impurity and a copper impurity in a chemical fluid containing ammonia by a single operation.

### EXAMPLE 7

Evaluation for Removal of Metal from Circulating Fluid

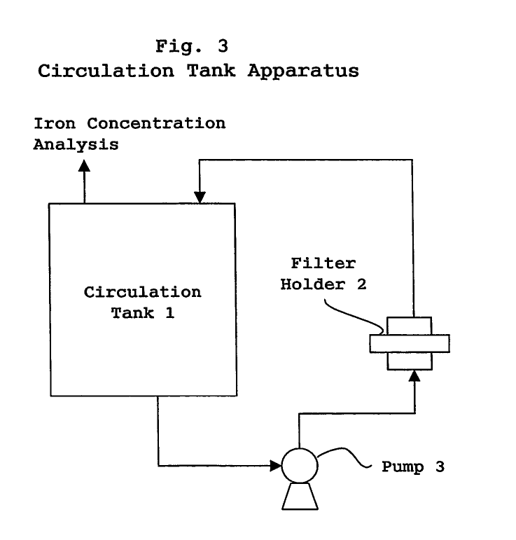

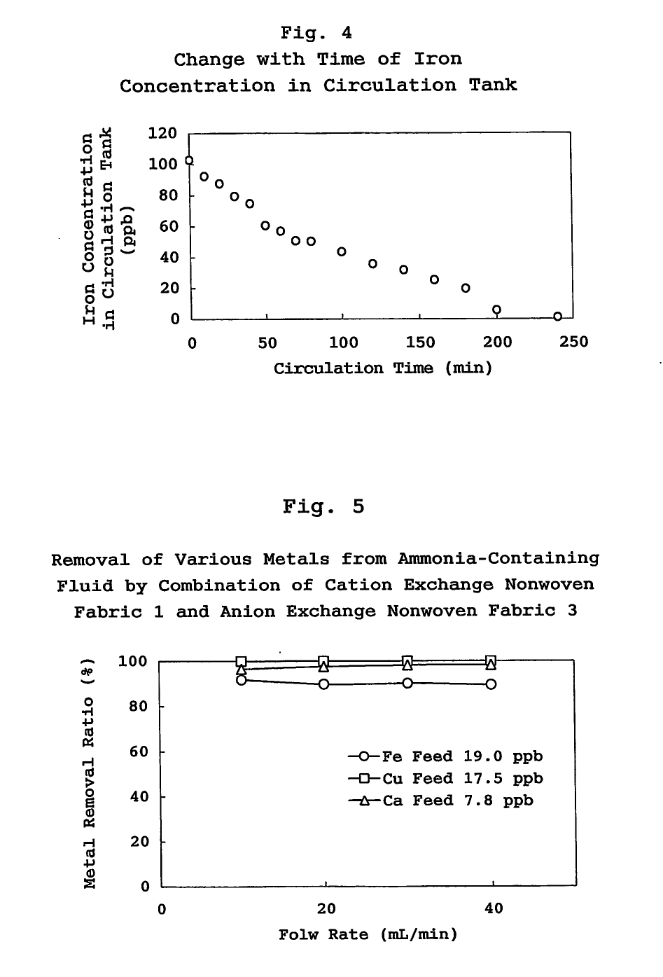

The quaternary ammonium type anion exchange nonwoven fabric 2 as prepared in Example 2 was cut into disks having a diameter of 47 mm (effective area: 13.1 cm²) and fixed to a filter holder 2 which was connected to a circulation tank 1 as shown in FIG. 3. In the circulation tank 1, 1,000 mL of a 1.5% ammonia aqueous solution containing 100 ppb of iron was placed, and this solution was circulated through the filter at a flow rate of 20 mL/min by a pump 3. The result of analyzing the change with time of the iron concentration in the circulation tank 1 is shown in FIG. 4. From FIG. 4, quick reduction of the iron concentration can be recognized.

### EXAMPLE 8

Evaluation for Removal of Iron, Copper and Calcium from Ammonia-Containing Fluid)

Experiment for evaluating removal of metals from an ammonia-containing fluid containing a plurality of metallic impurities was conducted using a composite membrane obtained by laminating the sulfonic acid type cation exchange nonwoven fabric 1 as prepared in Example 1 and the quaternary ammonium type anion exchange nonwoven fabric 2 as prepared in Example 2. The cation exchange nonwoven fabric 1 and the anion exchange nonwoven fabric 2 were cut into disks having a diameter of 47 mm (effective area: 13.1 cm²), respectively, and two sheets of each type of the disks were alternately superimposed and fixed to a filter holder. Through this laminated membrane, a 1% NaOH aqueous solution, pure water, a 5% hydrochloric acid aqueous solution, pure water and a 3% ammonia aqueous solution were passed in this order to thereby convert the sulfonic acid group to the ammonia type and the quaternary ammonium group to the Cl type, respectively. As the testing solution, a 3% ammonia aqueous solution containing 19 ppb of iron, 17.5 ppb of copper and 7.8 ppb of calcium was passed through the filter holder at a flow rate of 1.0 to 40 mL/min, and the concentration of each metal in the effluent was measured. The result is shown in FIG. 5. At a flow rate of the solution in this range, the iron concentration of the effluent was reduced to 1.5 ppb, the copper concentration was reduced to 0.1 ppb, and the calcium concentration was reduced to 0.2 ppb, and thus it was found that all metallic impurities could be well removed.

### EXAMPLE 9

Evaluation for Removal of Iron, Copper and Calcium from Photoresist Developer

Experiment for evaluating removal of metals from a photoresist developer containing a plurality of metallic impurities was conducted using a composite membrane obtained by laminating the sulfonic acid type cation exchange nonwoven fabric 1 as prepared in Example 1 and the iminodiethanol type chelating nonwoven fabric 3 as prepared in Example 3. The cation exchange nonwoven fabric 1 and the chelating nonwoven fabric 3 were cut into disks having a diameter of 47 mm (effective area: 13.1 cm²), respectively, and two sheets of each type of the disks were alternately superimposed and fixed to a filter holder. Through this laminated membrane, a 1% NaOH aqueous solution, pure water, a 5% hydrochloric acid aqueous solution, pure water and a 3% ammonia aqueous solution were passed in this order, to thereby convert the sulfonic acid group to the ammonia type and the iminodiethanol group to the free type, respectively. As the testing solution, a photoresist developer [a 2.38% aqueous solution of tetramethylammonium hydroxide (TMAH)] containing 21 ppb of iron, 16 ppb of copper and 53 ppb of calcium was passed through the filter holder at a flow rate of 20 mL/min, and the concentration of the metals in the effluent was analyzed. The iron concentration of the effluent was reduced to 3.9 ppb, the copper concentration was reduced to 1.6 ppb and the calcium concentration was reduced to 0.3 ppb, and thus it was found that all metallic impurities could be well removed.

### EXAMPLE 10

Evaluation for Removal of Iron and Copper from Photoresist Stripper

Experiment for evaluating removal of metals from a photoresist stripper containing a plurality of metallic impurities was conducted using a composite membrane obtained by laminating the sulfonic acid type cation exchange nonwoven fabric 1 as prepared in Example 1 and the amidoxime type chelating nonwoven fabric 4 as prepared in Example 4. The cation exchange nonwoven fabric 1 and the chelating nonwoven fabric 4 were cut into disks having a diameter of 47 mm (effective area: 13.1 cm²), respectively, and two sheets of each type of the disks were alternately superimposed, and fixed to a filter holder. Through this laminated membrane, a 1% NaOH aqueous solution, pure water, a 5% hydrochloric acid aqueous solution, pure water and a 3% ammonia aqueous solution were passed in this order, to thereby convert the sulfonic acid group to the ammonia type. As the testing fluid, a photoresist stripper (a product of Mitsubishi Gas Chemical Company, Inc., ELM-C30) added with 6.2 ppb of iron and 5.9 ppb of copper was passed through the filter holder at a flow rate of 20 mL/min, and the concentration of each metal in the effluent was measured. The iron concentration in the effluent was reduced to 1.8 ppb and the copper concentration was reduced to 1.4 ppb or less, and thus it was found that all metal impurities was well removed.

### EXAMPLE 11

Preparation of Pleated Type Filter Cartridge and Its Evaluation

One sheet of the sulfonic acid type cation exchange nonwoven fabric 1 as prepared in Example 1 and one sheet of the quaternary ammonium type anion exchange nonwoven fabric 2 as prepared in Example 2 were laminated with an effective width of 220 mm, and formed into a pleat having a crest height of 10 mm and a number of crests of 58. The effective area of this pleated laminated membrane was 0.26 m². This pleat was wound around a filter inner core (diameter: 46 mm, length: 220 mm) made of a high density polyethylene in such a manner that the cation exchange nonwoven fabric 1 came to the outside and the anion exchange nonwoven fabric 2 came to the inside, and inserted into a filter cage (inner diameter: 76 mm, height: 220 mm) and sealed with the use of a top cap and a bottom cap by the heat fusion bonding method to obtain a filter cartridge having a functional laminated membrane. This filter cartridge was treated with NaOH, pure water, hydrochloric acid, pure water and ammonia in this order in the same manner as in Example 8 to convert the sulfonic acid group into the ammonia type and the quaternary ammonium group to the Cl type, respectively. As the testing solution, a 3% ammonia aqueous solution containing 19 ppb of iron, 17.5 ppb of copper and 7.8 ppb of calcium was passed through the filter cartridge at a flow rate of 10 mL/min, and the concentration of each metal in the effluent was measured. The iron concentration in the effluent was reduced to 0.7 ppb, the copper concentration was reduced to 0.1 ppb or less and the calcium concentration was reduced to 0.1 ppb or less, and thus it was found that all metal impurities could be well removed.

### COMPARATIVE EXAMPLE 2

The sulfonic acid type cation exchange nonwoven fabric 1 as prepared in Example 1 was cut into a disk having a diameter of 47 mm. The disk was treated with 5% hydrochloric acid, and then the acid was removed with pure water. The obtained H-type sulfonic acid type cation nonwoven fabric was fixed to the filter holder. To an aqueous solution containing 1.2% by weight of TMAH and having a pH of 13.4, 8.3 ppb of iron was added as an impurity to prepare a testing solution. This testing solution was passed through the filter at a flow rate of 5.0 to 40 ml/min. The iron concentration in the filtrate was analyzed and found that it was in the range of 8.0 to 8.5 ppb. Thus the removal of the iron impurity was not observed at all.

Next, the quaternary ammonium type anion exchange nonwoven fabric 2 as prepared in Example 2 was cut into a disk having a diameter of 47 mm, and the disk was treated with a 0.5% sodium hydroxide aqueous solution, and then washed with pure water. The obtained disk was further washed with 5% hydrochloric acid and pure water in this order to obtain Cl-type quaternary ammonium type anion exchange nonwoven fabric. The same operation experiment was performed on the obtained anion exchange nonwoven fabric. The iron concentration in the filtrate was in the range of 8.1 to 8.4 ppb, and thus removal of the iron impurity was not observed at all.

Furthermore, the amidoxime type chelating nonwoven fabric 4 as prepared in Example 4 was cut into a disk having a diameter of 47 mm, and this disk was treated with a 0.5% sodium hydroxide aqueous solution and then washed with pure water and further treated with a 5% hydrochloric acid and then washed with pure water. The same operation experiment was performed on the obtained H-type amidoxime type chelating nonwoven fabric. The iron concentration in the filtrate was in the range of 8.2 to 8.3 ppb, and thus removal of the iron impurity was not observed at all.

From the above described experiments, it can be understood that the iron impurity in the photoresist developer cannot be removed with a sulfonic acid group, an amidoxime group or a quaternary ammonium group.

### COMPARATIVE EXAMPLE 3

The disk test piece of the H-type sulfonic acid type cation exchange nonwoven fabric as prepared in the same manner as in Comparative Example 2 was fixed to the filter holder. A testing solution was obtained by adding copper as an impurity to a photoresist stripper (a product of Mitsubishi Gas Chemical Company, Inc., ELM-C30) so as to render the copper concentration 170 ppb. The testing solution was passed through the filter at a flow rate of 20 mL/min, and the copper concentration in the filtrate was analyzed and found to be 145 ppb. Further, the same operation experiment was performed with the Cl-type quaternary ammonium type anion exchange nonwoven fabric as prepared in Comparative Example 2, and the copper concentration in the filtrate was 137 ppb. Furthermore, a 1% NaOH aqueous solution, pure water, a 5% hydrochloric acid aqueous solution, pure water and a 3% ammonia aqueous solution were passed through the iminodiethanol type chelating nonwoven fabric 3 prepared in Example 3 in this order to thereby convert the iminodiethanol group into the free type. The same operation experiment was performed with the obtained iminodiethanol type chelating nonwoven fabric, and the copper concentration in the filtrate was 83 ppb.

From the above experiment, it can be understood that the copper impurity in the photoresist stripper containing ammonia and hydrofluoric acid cannot be removed by a sulfonic acid group or a quaternary ammonium group, and with an iminodiethanol group, the removal efficiency is inferior.

1-10. (canceled)

11. A filter cartridge to be used in removing metallic impurities contained in a chemical fluid for treating the surface of an electronic device substrate by treating the chemical fluid, which cartridge has a filter material incorporated therein into which functional groups compatible with the existing morphology of target metallic impurities to be removed are introduced in compliance with the constituents of the target chemical fluid to be treated and the types of the metallic impurities to be removed.

12. The filter cartridge of claim 11, wherein the target chemical fluid to be treated contains an amine and/or an ammonium salt and/or hydrofluoric acid as the constituent.

13. The filter cartridge of claim 11, wherein the filter material is constituted of a fibrous material or a porous membrane material into which a functional group to be selected from a cation exchange, an anion exchange group, a chelate group and a combination thereof is introduced.

14. The filter cartridge of claim 13, wherein the fibrous material is constituted of a woven fabric base material or a nonwoven fabric base material.

15. A filter cartridge of claim 11, wherein the functional group is introduced into the base material by the graft polymerization method or the crosslinking polymerization method.

16. A filter cartridge for removing iron, copper and calcium from a fluid containing ammonia and hydrogen peroxide, into which functional groups composed of the combination of a strongly acidic cation exchange group with a quaternary ammonium group or an amidoxime group or a phosphonic acid group are introduced.

17. A filter cartridge for removing iron, copper and calcium from a photoresist developer, into which functional groups composed of the combination of a strongly acidic cation exchange group with a chelate group containing an amino group are introduced.

18. The filter cartridge of claim 17, wherein the chelate group containing an amino group is an iminodiethanol group, a diethylenetriamine group or a polyethyleneimine.

19. A filter cartridge for removing iron, copper and calcium from a photoresist stripper, into which functional groups composed of the combination of a strongly acidic cation exchange group with an amidoxime group or a phosphonic acid group are introduced.

20. A method of removing metallic impurities contained in a chemical fluid for treating the surface of an electronic device substrate by treating the chemical fluid, which method comprises passing the target chemical fluid to be treated through a filter cartridge of claim 11.

21. A method of removing metallic impurities contained in a chemical fluid for treating the surface of an electronic device substrate by treating the chemical fluid, which method comprises passing the target chemical fluid to be treated through a filter cartridge of claim 16.

22. A method of removing metallic impurities contained in a chemical fluid for treating the surface of an electronic device substrate by treating the chemical fluid, which method comprises passing the target chemical fluid to be treated through a filter cartridge of claim 17.

23. A method of removing metallic impurities contained in a chemical fluid for treating the surface of an electronic device substrate by treating the chemical fluid, which method comprises passing the target chemical fluid to be treated through a filter cartridge of claim 19.
